(19) United States
(12) Patent Application Publication
(10) Pub. No.: US 2024/0204399 A1
(43) Pub. Date: Jun. 20, 2024

(54) PHASED ARRAY ANTENNA MODULE WITH ROTATIONAL CONTROL

(71) Applicant: Google LLC, Mountain View, CA (US)

(72) Inventors: Ming SUN, Mountain View, CA (US); Mohammad Reza GHAJAR, Redwood City, CA (US)

(73) Assignee: Google LLC, Mountain View, CA (US)

(21) Appl. No.: 18/082,227

(22) Filed: Dec. 15, 2022

(51) Int. Cl. H01Q 3/04; H01Q 1/24; H01Q 3/30

(52) U.S. Cl. CPC H01Q 3/04; H01Q 1/241; H01Q 3/30

(57) ABSTRACT

Implementations described herein relate to a phased array antenna module with rotational control. In some implementations, a mobile device includes at least one processor, motion sensors configured to provide sensor data to the processor, and a phased array antenna module. The antenna module includes an antenna array that includes multiple antennas arranged linearly along a first axis. A rotary actuator is coupled to the antenna module and can rotate the phased array antenna module about a second axis that is parallel to the first axis. The processor performs operations including determining an orientation of the mobile device based at least on the sensor data from the motion sensors, and providing control signals based on the orientation of the mobile device to the rotary actuator to cause the rotary actuator to rotate the phased array antenna module about the second axis.

### BACKGROUND

Due to the demand for higher throughput over wireless links, millimeter wave communication (including part of the 5G™ network spectrum) has become increasingly popular on modern mobile consumer devices, such as mobile phones, tablets, and laptops. The implementation of millimeter wave (MMW) communication has challenges such as high propagation losses and high directivity. As a result, this communication often requires a direct line-of-sight with network access points (e.g., cell towers) to obtain reliable communication. Such characteristics may cause terminals and network deployment to have a high cost in order to achieve reliable user experience and network coverage for mobile devices, due to the need for a large number of network access points to accommodate different locations and orientations of mobile devices in use by users. Some mobile devices may include phased array antennas that can provide electronic directional control to signals transmitted from the device using beam steering techniques to mitigate some directional limitations of MMW signals.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to a phased array antenna module with rotational control and devices and methods using same. In some implementations, a mobile device includes at least one processor, one or more motion sensors configured to provide sensor data to the processor, and a phased array antenna module. The antenna module includes an antenna array that includes a plurality of antennas arranged linearly along a first axis. A rotary actuator is coupled to the phased array antenna module and configured to rotate the phased array antenna module about a second axis that is parallel to the first axis. The processor is configured to perform operations including determining an orientation of the mobile device based at least on the sensor data from the one or more motion sensors, and providing control signals based on the orientation of the mobile device to the rotary actuator to cause the rotary actuator to rotate the phased array antenna module about the second axis.

Various implementations of the device are described. For example, in some implementations, the rotary actuator includes a motor including a rotor, and the device further includes an elongated shaft coupled to the rotor and to a substrate of the phased array antenna module, the elongated shaft extending along the second axis, wherein the motor is configured to rotate the elongated shaft to cause the phased array antenna module to rotate about the second axis. In some implementations, the rotary actuator is a first rotary actuator, and the device further comprises a second rotary actuator coupled to the phased array antenna module, the second rotary actuator being configured to rotate the phased array antenna module about a third axis that is orthogonal to the first axis and to the second axis. In some implementations, the processor is configured to perform operations that further include causing a millimeter wave (MMW) signal to be transmitted via the phased array antenna module, wherein the transmitted MMW signal is moved closer to a target antenna of a receiving device via the rotation of the phased array antenna module about the second axis. In some implementations, the motions sensors include one or more gyroscopes. In some implementations, the at least one processor is configured to control the antennas to steer antenna beams about a second axis.

In some implementations, a method is implemented in a mobile communication device including a phased array antenna module that includes a plurality of antennas arranged along a first axis, the module being coupled to a rotary actuator. The method includes determining a direction of a base antenna relative to the mobile communication device. The method includes detecting a change in orientation of the mobile communication device. Responsive to the detected change in orientation, the method includes sending first control signals to the rotary actuator of the mobile device to cause the phased array antenna module to rotate about a second axis toward the base antenna, wherein the second axis is parallel to the first axis. The method includes causing signals to be transmitted by the antennas in a second direction resulting from the rotation of the phased array antenna module.

Various implementations of the method are described. For example, in some implementations, the method includes determining that the phased array antenna module is misaligned with the base antenna by being oriented in a first direction that is spaced from the base antenna by an angle amount, and sending the first control signals to the rotary actuator includes causing the phased array antenna module to selectively rotate based on the angle amount. In some implementations, the rotary actuator includes a motor including a rotor, an elongated shaft is coupled to the rotor and to a substrate of the phased array antenna module, the elongated shaft extends along the second axis, and the motor is configured to rotate the elongated shaft to cause the phased array antenna module to rotate about the second axis. In some implementations, the rotary actuator is a first rotary actuator, and the method further includes sending second control signals to a second rotary actuator coupled to the phased array antenna module to cause the phased array antenna module to rotate about a third axis toward the base antenna, the third axis being orthogonal to the first axis and to the second axis. In some implementations, causing the signals to be transmitted includes providing electronic beam steering of the signals to rotate a direction of transmission of the signals about a third axis that is transverse to the first axis.

### BRIEF DESCRIPTION OF THE DRAWINGS

FIG. 1 shows a perspective view of an example mobile device which may be used for one or more implementations described herein.

FIGS. 2 and 3 are perspective views of example antenna module assemblies which can provide rotational control to antenna modules, according to some implementations.

FIG. 4 is a flow diagram illustrating an example method to directionally control an antenna module of a device, according to some implementations.

FIG. 5 is a block diagram of an example device which may be used to implement one or more features described herein.

### DETAILED DESCRIPTION

This disclosure relates to a phased array antenna module with directional control and devices and methods using same. A mobile device can include a phased array antenna module that includes an antenna array having multiple antennas arranged linearly on a substrate along a first axis. A rotary actuator, such as a motor, is coupled to the antenna module and can rotate the antenna module about a second axis that is parallel to the first axis in response to receiving control signals from a processor on the mobile device. This allows the processor to control physical rotation of the antenna module to steer and transmit signals at millimeter wave (MMW) frequencies in directions in which the signals cannot be steered with beam steering of the antenna array.

In some examples, the device processor can determine an orientation of the mobile device based on sensor data from motion sensors of the device such as gyroscope(s) and accelerometers, and can determine whether to control rotation of the antenna module to adjust the direction of signals so that they are transmitted closer to a target antenna (e.g., base antenna) that receives the signals. Some implementations can include a second rotary actuator to rotate the antenna module about an axis orthogonal (e.g., transverse) to the first and/or second axis, which directs transmitted signals about the same axis as beam steering and increases the range over which signals can be transmitted about that axis.

Described features advantageously provide increased directional control of an antenna module for transmission of MMW signals from a mobile device. For example, in some previous devices, beam steering can be used to direct a signal (beam) from a phase array antenna module to different directions using multiple antennas of the phase array. The signal is steered electronically by, e.g., controlling the phases of signals from each antenna element. The beam can be adjusted in its direction to find a base antenna of a base station.

However, electronic beam steering is limited in the directions that it can steer a signal. The phase array can steer a signal parallel to the axis along which the array antennas are positioned but cannot steer the beam along other device axes. Steering along other axes may be needed to precisely align the transmitted signal toward a base antenna, e.g., after the user has moved the mobile device to a new orientation.

Features described herein include mechanisms to provide and control physical rotation of an antenna module about a different axis of the device than allowed by beam steering, thus enabling transmitted signals (e.g., beams) to be controlled in their direction over a greater range, and increasing the ability of the device to align the signals with a target antenna of a receiving device, such as a base antenna of a base station. In some implementations, described mechanisms can provide rotation of the module in the different axis as well as rotation about the axis used for beam steering transmitted signals, thus increasing the ability to align transmitted signals with a base antenna.

Technical advantages of described features thus include increased efficiency of transmission of MMW signals by allowing more precise alignment of transmitted signals with a target antenna. Described features can reduce losses of power in signals received at an antenna and allow increased distance at which base antennas can be located to reliably receive MMW signals transmitted by mobile devices.

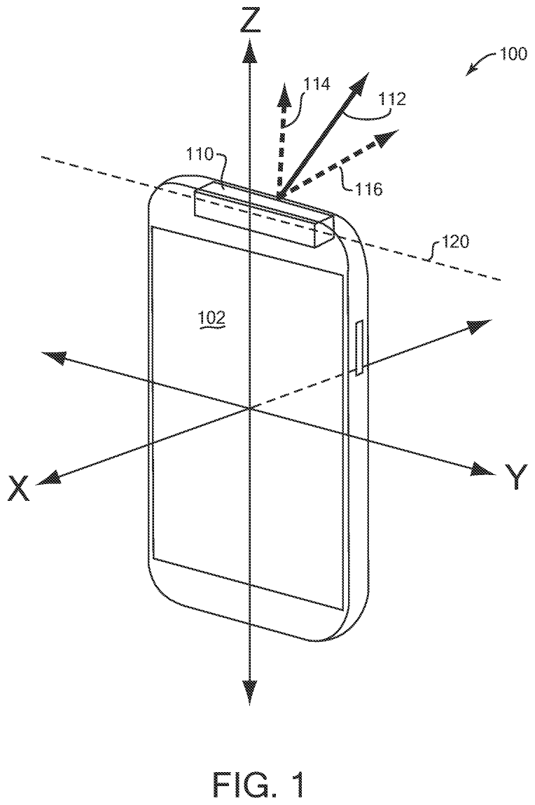

FIG. 1 illustrates a perspective view of a device 100 that can be used with antenna module features described herein, according to some implementations. Device 100 can be, for example, a mobile device such as a cell phone, smartphone, tablet, wearable device (e.g., display glasses or goggles, wristwatch, headset, wristband, armband, jewelry, etc.), personal digital assistant (PDA), media player, portable game device, device embedded in a vehicle, etc.

Device 100 generally can be held (or worn) by the user and operated in any location. In some implementations, a user can operate a touchscreen 102 that displays various information and can receive input from the user via touch. One or more other input and output devices can also or alternatively be provided on device 100, e.g., audio speakers, microphones, physical buttons, trackpads, etc.

Device 100 can communicate wirelessly with one or more base stations that can include, for example, cell phone towers or other wireless signal devices that include one or more base antennas enabling transmission and reception of signals. Base stations can also include booster devices that amplify signals from other transmitting devices. In some examples, device 100 can receive wireless signal transmissions from a base station that is located within a particular distance to the geographical location of the device 100.

Device 100 is capable of receiving and transmitting millimeter wave (MMW) signals, which are signals having frequencies approximately within the band of 30-300 GHz (e.g., extremely high frequency (EHF) or millimeter band). For example, 5G cell phone networks may include communication at MMW frequencies of 24 GHz and higher (as well as lower frequency bands).

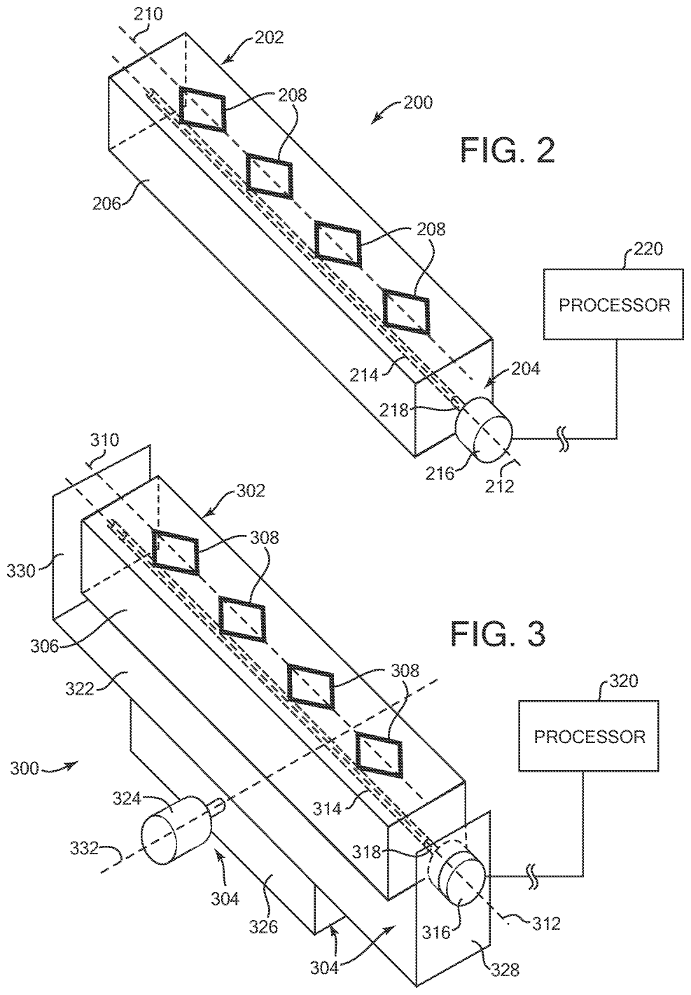

Device 100 includes one or more antenna modules that enable communication with wireless receiving devices, such as base stations, via wireless signals. In the described examples, device 100 includes a phased array antenna module 110 which includes multiple antennas configured in an antenna array. The antenna array focuses a wireless signal in a particular direction, increasing power radiated in that direction and decreasing power radiated in other directions. For example, the antennas of module 110 can be arranged in one or more rows or lines on a substrate, similarly as described below with respect to FIGS. 2 and 3. Some implementations can include multiple substrates or modules with antenna arrays. In some implementations, multiple such rows of antennas can be on a single substrate, or can be provided on separate substrates. In some implementations, phased array antenna module 110 is connected to various other components enabling communication using the antenna module, e.g., a phased array radio frequency (RF) transceiver, intermediate frequency (IF) transceiver, etc. In some implementations, phased array antenna module 110 can include one or more of these other components, e.g., in an antenna-in-package (AIP) module. In some implementations, antenna module 110 can be a component (e.g., substrate or board) that is separate from other circuitry and connected to that circuitry via electrical connections.

Phased antenna module 110 is oriented to transmit MMW signals in a particular direction. For example, in the example of FIG. 1, antenna module 110 is oriented such that it transmits signals in the direction indicated by arrow 112. The antennas of antenna module 110 can be positioned in a line along an axis that is parallel with the Y-axis of device 100 shown in FIG. 1, and module 110 is oriented at a rotational position about that axis such that it transmits signals in direction 112. This direction is away from the back of the device and up from the device when device 100 is oriented as shown in FIG. 1. For example, a base antenna may commonly be positioned in this direction relative to the device 100 when the device is in use. Antenna module 110 can be oriented to transmit MMW signals in other directions besides direction 112 in other implementations (or when controlled to do so using features described herein).

The phased array of antennas of antenna module 110 allows beam steering of signals transmitted by device 100, where a signal is steered electronically by controlling the phase and amplitude of the RF signals driving each antenna element (and/or by switching antenna elements), e.g., using a radio frequency integrated circuit (RFIC) transceiver coupled to the antenna module. For example, current from a transmitter is sent to multiple antennas with a particular phase relationship such that signals from the antennas combine to form beams in a direction corresponding to the phase relationship. The direction of transmission can be changed by manipulating the signals. For example, phase shifters can be used to change the phases of the signals emitted from the antennas and steer the transmitted resulting signal (beam). The phase array can steer a signal parallel to the axis along which the array antennas are positioned. Signals can thus be transmitted from module 110 in a particular range of directions to increase power and range of the signals, e.g., in directions in which a base antenna is located and can receive the transmitted signals.

In the example of FIG. 1, the transmitted signal can be steered left and right along the axis of the antennas of the array, e.g., along the Y-axis in FIG. 1 as shown by example directions 114 and 116. In some implementations, a transmitted signal can be steered to provide a more direct transmission and thus stronger signal to a base antenna. For example, if device 100 is rotated about the Z-axis of the device shown in FIG. 1, rotating the direction of transmission of emitted signals along the Y-axis (e.g., about the Z-axis) may compensate for the device rotation by maintaining the direction of the transmitted signals toward the base antenna.

In some cases, device 110 is moved and/or reoriented by the user such that electronic beam steering (by manipulating the phases of signals emitted by the antenna array) cannot steer the transmitted signals toward or closer to a base antenna. For example, if device 100 is rotated about the Y-axis, such beam steering may not be able to compensate for the rotation since the beam steering cannot change the direction of transmitted signals along an axis parallel to the Z-axis (e.g., about an axis parallel to the Y-axis).

According to features described herein, antenna module 110 can be controlled by at least one processor of device 100 to physically rotate about an axis that is parallel to the axis along which the antennas are arranged and along which the transmitted signal can be steered via electronic beam steering. For example, with reference to FIG. 1, antenna module 110 can be rotated about an axis 120 that is parallel to the Y-axis, which moves the transmitted signal in directions along the Z-axis (e.g., up and/or down). The antenna module is rotated about the Y-axis that is orthogonal to the axis of rotation of beam steering signals (e.g., an axis in the X-Z plane). The rotation of antenna module 110 allows transmitted signals to be transmitted toward (e.g., closer to) a base antenna that may have shifted in its position relative to device 100, e.g., along the Z-axis due to device movement and rotation by the user. Additional examples of antenna module 110 and this rotation are described below with reference to FIGS. 2 and 3.

In some cases, device 100 may be rotated by the user approximately about the Z-axis. Some of this rotation can be compensated for by beam steering transmitted signals as described above. However, such device rotation may be large such that the maximum amount of beam steering allowed by the phased array is not sufficient to align transmitted signals close enough to the base antenna to provide a strong signal to the base antenna.

In some implementations, according to features described herein, antenna module 110 can be controlled by at least one processor of device 100 to physically rotate about the axis about which the transmitted signal can be steered via beam steering. For example, with reference to FIG. 1, antenna module 110 can be rotated about an axis that is approximately parallel to the Z-axis (e.g., an axis in the X-Z plane), which moves the transmitted signal 112 along the Y-axis (e.g., left or right). This rotation of the module 110 about the beam steering axis provides additional rotation about that axis than allowed by electronic beam steering alone. This allows signals to be transmitted toward (e.g., closer to) a base antenna that may have shifted in its position relative to device 100 beyond the range of beam steering signals due to device movement. Examples of antenna module 110 and this rotation are described below with reference to FIG. 3.

FIG. 2 is a perspective view of an example antenna assembly 200 that can be used in a mobile device, according to some implementations. For example, antenna assembly 200 can be or include antenna module 110 in device 100 of FIG. 1, or can be provided in a different device. Assembly 200 includes an antenna module 202 and a rotation mechanism 204.

Antenna module 202 can include a substrate 206 and multiple antennas 208. Substrate 206 can be any suitable material on which to position antennas 208, e.g., a package, circuit board, etc. In various implementations, one or more additional components can be included in substrate 206 and/or can be connected to substrate 206 via circuitry and/or connectors.

Antennas 208 can be pieces of metal via which wireless signals can be received and transmitted. In the example of FIG. 2, each antenna 208 is a patch antenna that is a flat, square piece of metal, but can be provided in other shapes, sizes, thicknesses, etc. in other implementations. In this example, antennas 208 are provided in a linear configuration along an axis 210, that can be a longitudinal axis as shown in FIG. 2 or can be another axis of the substrate. Other configurations can be provided in other implementations, e.g., a grid of antennas. In some example implementations, a spacer that provides an air gap can be provided at the bottom of substrate 206 (in the orientation shown in FIG. 2) and a ground plane can be provided at the bottom of substrate 206 below the spacer (not shown).

Rotation mechanism 204 is coupled to the substrate 206 and includes an elongated shaft 214 and a rotary actuator, which is a motor 216 in some implementations. Shaft 214 is rigidly coupled to substrate 206 and can extend at least partially (or fully) along the length of substrate 206 parallel to an axis 212. Axis 212 is parallel to axis 210 along which the antennas 208 are aligned. In some examples, axis 212 can be parallel to the Y-axis shown in FIG. 1.

One end 218 of shaft 214 is rigidly coupled to a rotor of motor 216. Motor 216 can be a rotary motor, e.g., a stepper motor or other motor that outputs rotary force around axis 212 based on control signals received by the motor. Motor 216 can be coupled to a local mechanical ground, e.g., a frame or structure of the device that houses assembly 200. Motor 216 rotates its rotor and shaft 214 about axis 212 based on received control signals. Motor 216 outputs rotational force to cause substrate 206 and antennas 208 to rotate about axis 212.

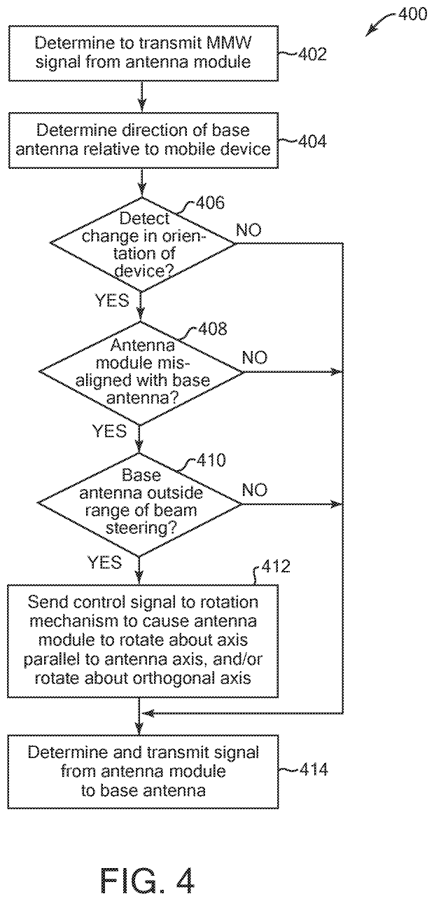

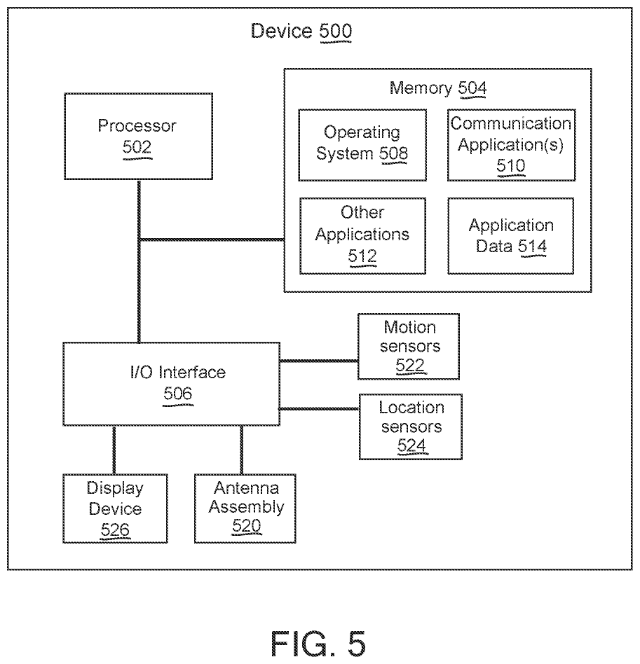

Control signals can be received by motor 216 from at least one processor 220 that is included in the device that houses antenna assembly 200 (e.g., device 100 of FIG. 1). Some examples of processor 220 are described below with reference to FIG. 5. Processor 220 can receive signals from a base antenna of a base station (or other device) and, based on the signals, determine whether signals transmitted by antenna module 202 should be changed in transmission direction, via beam steering of the antenna array and/or via control of motor 216 to rotate antenna module 202. Some examples of this operation are described below with respect to FIG. 4.

FIG. 3 is a perspective view of another example of an antenna assembly 300 that can be used in a mobile device, according to some implementations. For example, antenna assembly 300 can be or include antenna module 110 in device 100 of FIG. 1, or can be provided in a different device. Assembly 300 can rotate an antenna module about two different axes. Assembly 300 includes an antenna module 302 and a rotation mechanism 304.

Antenna module 302 can include a substrate 306 and multiple antennas 308. In some implementations, substrate 306 and antennas 308 can be similar to substrate 206 and antennas 208, respectively, that are described above with reference to FIG. 2. In various implementations, one or more additional components can be included in substrate 306 and/or can be connected to substrate 306 via circuitry and/or connectors. In this example, antennas 308 are provided in a linear configuration along an axis 310, that can be a longitudinal axis as shown in FIG. 3 or can be another axis of the substrate. Other configurations can be provided in other implementations, e.g., a grid of antennas. In some example implementations, a spacer that provides an air gap can be provided at the bottom of substrate 306 (in the orientation shown in FIG. 3) and a ground plane can be provided at the bottom of substrate 306 below the spacer (not shown).

Rotation mechanism 304 includes an elongated shaft 314, a first rotary actuator (e.g., first motor 316), a frame 322, a second rotary actuator (e.g., second motor 324), and a support 326.

In various implementations, rotation mechanism 304 is coupled to substrate 306 and outputs force to cause substrate 306 and antennas 308 to rotate about an axis 312. Axis 312 is parallel to axis 310 along which the antennas 308 are aligned. In some examples, axis 312 can be parallel to the Y-axis shown in FIG. 1. Elongated shaft 314 is rigidly coupled to substrate 306 and can extend at least partially (or fully) along the length of substrate 306 parallel to axis 312. One end 318 of shaft 314 is rigidly coupled to a rotor of first motor 316. First motor 316 can be a rotary motor, e.g., a stepper motor or other motor that outputs rotary force around axis 312 based on control signals received by the motor. First motor 316 rotates its rotor and shaft 314 about axis 312 based on received control signals from microprocessor 320.

Frame 322 can be rotatably coupled to antenna module 302 to allow antenna module 302 to rotate with respect to frame 322. In some implementations, the housing of first motor 316 can be rigidly coupled to a first portion 328 of frame 322. In this example, shaft 314 extends out of the side of substrate 306 that is opposite to first motor 316 and is rotatably coupled to a second end 330 of frame 322. With the rotary couplings of shaft 314 and first motor 316 to frame 322, first motor 316 can rotate antenna module 302 independently of frame 322.

Second motor 324 can be used to rotate assembly 300 about an axis 332. Support 326 is coupled to a rotor of second motor 324, and frame 322 is coupled to support 326. In some implementations, support 326 can be part of frame 322. Second motor 324 can be a rotary motor, e.g., a stepper motor or other motor that outputs rotary force around axis 332 based on control signals received by motor 324. Based on received control signals from processor 320, second motor 324 rotates its rotor which causes support 326 and frame 322 to rotate about axis 332, which causes antenna module 302 and rotation mechanism 304 to rotate about axis 332 with frame 322. Axis 332 is orthogonal to axes 310 and 312. Rotation of antenna module about axis 332 as caused by second motor 324 is rotational motion in the same degree of freedom as transmitted signals beam steered from antenna module 302, thus providing additional rotational range to the transmitted signals outside of the beam steering range.

In some implementations, first control signals can be received by first motor 316 and second control signals can be received by second motor 324 from at least one processor 320 that is included in the device that houses antenna assembly 300 (e.g., device 100 of FIG. 1). Some examples of processor 320 are described below with reference to FIG. 5. Processor 320 can receive signals from a base antenna of a base station (or other device) and, based on the signals, determine whether signals transmitted by antenna module 302 should be changed in transmission direction, via beam steering of the antenna array and/or via control of first motor 316 and/or second motor 324 that rotate antenna module 302 about respective axes 312 and 332. Some examples of this operation are described below with respect to FIG. 4.

In some implementations of assemblies 200 and 300, motors 216, 316, and/or 324 can be implemented as other types of actuators that outputs forces based on control signals, where the forces cause the antenna module to rotate about the axes described above. For example, a linear actuator such as a voice coil can be used to output linear forces that are converted to rotary forces that rotate the antenna module.

In some implementations, rotation mechanism 204 and/or rotation mechanism 304 can include one or more MEMS (Micro Electro Mechanical Systems) devices or other integrated devices that can rotate antenna module 202 or 302 about axes similarly as described above. For example, a MEMS actuator can be used as a rotary actuator instead of or in addition to motor 216/316 of FIG. 2 or FIG. 3 to provide rotation of antenna module 202 about axis 212 or an axis parallel to axis 212. In some examples, a MEMS actuator can be positioned to a side of substrate 216 and a rotating element (rotor) of the MEMS actuator can be rigidly coupled to the side of substrate 216. The rotor can be rotated by the MEMS actuator to cause rotation of antenna module 202 about axis 212 or an axis parallel to axis 212. In further examples, one or more MEMS actuators can be used instead of or in addition to motors 316 and 324 of FIG. 3 (and, e.g., without other components of antenna assembly 300 such as frame 322 and support 326) to provide rotation of antenna module 302 about multiple axes such as axis 312 and axis 332 (or about axes parallel to those axes). In some examples, a MEMS actuator can be positioned under substrate 216 and a rotor of the MEMS actuator can be rigidly coupled to the bottom of substrate 216. The rotor can be rotated by the MEMS actuator to cause tilting or rotation of antenna module 302 about axis 332 (or a parallel axis). In another example, a MEMS actuator can include a rotor that can tilt or rotate in multiple degrees of freedom, including about axis 312 and axis 332 (or parallel axes). For example, a planar rotor coupled to the bottom of substrate 306 (in the orientation of FIG. 3) can be tilted about either of these axes by the MEMS actuator.

FIG. 4 is a flow diagram illustrating an example method 400 to rotationally control an antenna module of a device, according to some implementations. In some implementations, method 400 can be implemented, for example, by a device such as a mobile device, e.g., device 100 as shown in FIG. 1. In described examples, the implementing device includes one or more digital processors or processing circuitry (“processors”), and can include one or more storage devices (e.g., memory or other storage), examples of which are described below.

Method 400 may begin at block 402. In block 402, it is determined to transmit a MMW signal from the antenna module of the mobile device to a target antenna of a receiving device, such as a base antenna of a base station. Block 402 may be followed by block 404.

In block 404, a direction of the base antenna is determined relative to the mobile device. In some implementations, this can be determined, at least in part, using base signals received by the mobile device from the base antenna. For example, a mobile device held by a user can receive MMW signals and determine the location of the base antenna. Other information can also be used to determine the location of the base antenna, e.g., map or location information received from internet sources, etc. Block 404 may be followed by block 406.

In block 406, it is determined whether the orientation of the mobile device has changed in space. For example, the user may have moved the device, including tilting the device, facing or pointing the device in a different direction, etc. The current orientation of the device, and the change in the orientation, can be determined using one or more motion sensors included in the device. For example, a gyroscope can be used to detect the orientation of the device, including pitch, roll and yaw rotations, and accelerometers can be used to detect acceleration along the axes of the device (e.g., axes shown in FIG. 1). In some implementations, one or more location sensors can be used, e.g., a magnetometer can define device orientation in a magnetic field. Sensor fusion can be used to combine data of such sensors to achieve more accurate determination of device orientation. Suitable gyroscopes and accelerometers include MEMS gyroscopes and accelerometers that are compact devices that fit in the device housing.

If no change in orientation of the device is detected in block 406, the method may continue to block 414, described below. If a change in orientation of the device is detected in block 406, the method may continue to block 408.

In block 408, it is determined whether the antenna module of the device (and thus MMW signals transmitted by the device) are misaligned with the base antenna. The MMW signals transmitted by the device are directional and thus the antenna module can direct signals to a location within a particular distance range of the base antenna so that transmitted signals reach the base antenna with sufficient strength. The antenna module may be misaligned with the base antenna by being oriented in a first direction that is spaced from the base antenna by an angle amount, e.g., at least a threshold angle, or by another threshold measure. For example, the current device orientation (and/or device location) determined in block 406 can be compared to the location of the base antenna detected in block 402, and if the device and antenna module are oriented in a direction spaced from the base antenna by more than a threshold angle, and/or the antenna module is aimed to a location that is spaced from the base antenna by at least a threshold distance, the device is considered misaligned. In some implementations, various other characteristics can be used to determine such misalignment, e.g., the power or other characteristics of received signals from the base antenna, GPS location of the device compared to known location of base antenna, etc.

If the antenna module is determined in block 408 to be aligned with the base antenna, the method may continue to block 414, described below. If the antenna module is determined in block 408 to be misaligned with the base antenna, the method may continue to block 410.

In block 410, it is determined whether the base antenna is outside the range of beam steering provided by the antenna module. If the base antenna is determined not be outside the range of beam steering, the method may continue to block 414 to determine the signal and its direction, where misalignment between antenna module and base antenna can be compensated by beam steering. If the base antenna is determined in block 410 to be outside the range of beam steering, the method may continue to block 412.

In block 412, one or more control signals are sent by the processor of the device to the rotation mechanism of the device to cause the antenna module to rotate about an axis of the device that is parallel to an antenna axis along which the antennas of the array are arranged. This provides rotation of the antenna module that is relative to the device (e.g., relative to the housing and other components of the device). The control signals can be based on the orientation of the mobile device, e.g., to instruct a selective amount of rotation based on the angle amount (or other measure) between the antenna module and base antenna as determined above. For example, the amount of rotation can compensate for the difference in orientation angle between antenna module direction and base antenna (e.g., rotation to cause the antenna module direction to be oriented within the threshold angle of the base antenna). For example, a rotation mechanism as in assembly 200 of FIG. 2 can be used, which includes a motor (or other rotary actuator) that receives control signals that cause it to rotate the antenna module about axis 212 (that is parallel to the antenna axis 210) by an amount indicated by the control signals. In some implementations, the control signals include first control signals that cause the antenna module to rotate about the antenna axis and second control signals that cause the antenna module to rotate about an orthogonal axis that is orthogonal (e.g., transverse) to the antenna axis. For example, using a rotation mechanism as in the assembly 300 of FIG. 3, the first control signals can be provided to first motor 316 to control a selective amount of rotation of the antenna module about the axis 312 parallel to antenna axis 310, and the second control signals can be provided to second motor 324 to control a selective amount of rotation of the antenna module about axis 332 that is orthogonal (e.g., transverse) to antenna axis 310.

The rotation of the antenna module provided in block 412 can adjust the direction of the antenna module such that transmitted MMW signals will be closer to the detected base antenna than if the antenna module is maintained in its previous rotational orientation relative to the device. Block 412 can be performed in response to determining in block 410 that beam steering of signals will not be sufficient to align the transmitted signals with the base antenna, and thus the rotation provided in block 412 can align or move transmitted signals toward the base antenna, e.g., closer to the base antenna than is possible with beam steering alone. In some implementations, the rotation of the antenna module in block 412 can be performed to align transmitted signals to the base antenna without beam steering being performed. Block 412 may be followed by block 414.

In block 414, one or more device signals are determined and transmitted from the antenna module toward the base antenna. For example, if block 414 is performed after block 406 or 408, the signal can be determined and transmitted without beam steering and without rotation of the antenna module, since the antenna module is aligned with the base antenna. If block 414 is performed after block 410, then beam steering can be performed to change the direction of the transmitted signal to align the signal to the base antenna, using beam steering techniques for the phased array antenna module as described above.

If block 414 is performed after block 412, the signal is transmitted from the antenna module that has been rotated about one or more axes in block 412. In this case, beam steering of the transmitted signal may or may not be performed in various implementations or cases. For example, if the rotation of the antenna module performed in block 412 is sufficient to align the antenna module with the base antenna, beam steering can be omitted. If the rotation of the antenna module in block 412 is not sufficient to align the module, and if beam steering is appropriately oriented to direct transmitted signals closer to the base antenna, then such beam steering can be performed. For example, beam steering can steer the transmitted signal about an axis that is orthogonal to the antenna axis described above, e.g., along an axis that is parallel to the antenna axis.

In various implementations, various blocks of method 400 may be combined, split into multiple blocks, performed in parallel, or performed asynchronously. In some implementations, one or more blocks of method 400 may not be performed or may be performed in a different order than shown in FIG. 4. For example, in various implementations, blocks 406, 408, and/or 410 can be performed in a different order and/or at least partially simultaneously. Method 400, or portions thereof, may be repeated any number of times using additional inputs.

FIG. 5 is a block diagram of an example device 500 which may be used to implement one or more features described herein. In some examples, device 500 may be used to implement a client device, e.g., a mobile device 100 shown in FIG. 1, or any mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc. Alternatively, device 500 can implement a different type of device, e.g., server device, desktop computer device, etc. Device 500 can be any suitable computer system, server, or other electronic or hardware device as described above.

Features described herein can operate in several environments and platforms. In some implementations, all operations can be performed within a mobile device. In some implementations, a client/server architecture can be used, e.g., a mobile device (as a client device) sends data to a server device (e.g., sensor data such as device location data and motion sensor data) and receives data from the server (e.g., locations and/or directions of closest base antennas and base stations, etc.) to be used in operations by the client device. In another example, operations can be split between the mobile device and one or more server devices.

In some implementations, device 500 includes a processor 502, a memory 504, and input/output (I/O) interface 506. Processor 502 can be one or more processors and/or processing circuits to execute program code and control basic operations of the device 500. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some implementations, processor 502 may include one or more co-processors that implement neural-network processing. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems.

Memory 504 is provided in device 500 for access by the processor 502, and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 502 and/or integrated therewith. Memory 504 can store software operating on device 500 by processor 502, including an operating system 508, one or more communication application(s) 510, other applications 512, and application data 514. In some implementations, communications application(s) 510 can control communications between devices including transmission and reception of wireless signals as described herein. Communications application 510 can include instructions that enable processor 502 to perform functions described herein, e.g., some or all of blocks of method 400 of FIG. 4. In some implementations, data used in communications operations can be stored as application data 514 or other data in memory 504, and/or on other storage devices of one or more other devices in communication with device 500. Other applications 512 may include applications such as a data display engine, image editing applications, navigation and map applications, notification engine, social networking engine, media display applications, web hosting engines or applications, media sharing applications, etc.

Any of software in memory 504 can alternatively be stored on any other suitable storage location or computer-readable medium. Memory 504 and any other type of storage (magnetic disk, optical disk, magnetic tape, or other tangible media) can be considered “storage” or “storage devices.”

I/O interface 506 can provide functions to enable interfacing processor 502 and memory 504 with other components of device 500 and with other devices. Interfaced devices can be included as part of the device 500 or can be separate and communicate with the device 500. For example, network communication devices, storage devices (e.g., memory and/or database), and input/output devices can communicate via I/O interface 506. In some implementations, the I/O interface can connect to interface devices such as input devices (keyboard, pointing device, touchscreen, microphone, camera, scanner, sensors, etc.) and/or output devices (display devices, speaker devices, printers, motors, etc.). In some implementations, hardware used for components of device 100 of FIG. 1 can be included in I/O interface or other connected components of device 500.

Some examples of interfaced devices that can connect to I/O interface 506 can include one or more antenna assemblies 520 that can be implemented as any of the antenna assemblies described herein. For example, control signals can be sent from processor 502 to motor(s) coupled to an antenna module of assembly 520. Motion sensors 522 can be connected to I/O interface 506 (and/or directly to processor 502/memory 504) and can include sensor devices such as gyroscopes, accelerometers, and other sensors that can detect motion of the device 100 including linear motion, rotation and/or orientation, or other motion. Location sensors 524 can be connected to I/O interface 506 (and/or directly to processor 502/memory 504) and can determine a location or direction of the device 500, e.g., sensors such as magnetometers, Global Positioning Sensors (GPS), etc. For examples, sensor data from gyroscopes, accelerometers, and/or magnetometers can be used to determine an orientation and/or motion of the device 500 in space.

One or more display devices 526 can be used to display content, e.g., images, video, and/or a user interface of an application. Display device 526 can be connected to device 500 via local connections (e.g., display bus) and/or via networked connections and can be any suitable display device, e.g., an LCD, LED, or plasma display screen, CRT, television, monitor, touchscreen, 3-D display screen, or other visual display device. Display device 526 may also act as an input device, e.g., a touchscreen input device such as a flat display screen provided on a mobile device, multiple display screens provided in glasses or a headset device, a monitor screen for a computer device, etc. The I/O interface 506 can interface to other input and output devices (not shown). Some examples include one or more cameras which can capture images and/or detect gestures, one or more microphones for capturing sound such as speech or other sounds emitted from a user, a radar or other sensors for detecting gestures, audio speaker devices for outputting sound, etc.

Any of software in memory 504 can alternatively be stored on any other suitable storage location or computer-readable medium. Memory 504 and any other type of storage (magnetic disk, optical disk, magnetic tape, or other tangible media) can be considered “storage” or “storage devices.”

For ease of illustration, FIG. 5 shows one block for each of processor 502, memory 504, I/O interface 506, software blocks 508-514, sensors, antenna assemblies, etc. These blocks may represent one or more processors or processing circuitries, operating systems, memories, I/O interfaces, applications, devices, components, and/or modules. In other implementations, device 500 may not have all of the components shown and/or may have other elements including other types of elements instead of, or in addition to, those shown herein. While some components are described as performing blocks and operations as described in some implementations herein, any suitable component or combination of components, similar devices, or any suitable processor or processors associated with such a device, may perform the blocks and operations described.

Methods described herein, or portions thereof, can be implemented by computer program instructions or code, which can be executed on a computer. For example, the code can be implemented by one or more digital processors described herein (e.g., microprocessors or other processing circuitry) and can be stored on a computer program product including a non-transitory computer-readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively or additionally, one or more methods or portions thereof can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

Although the description has been described with respect to particular implementations thereof, these particular implementations are merely illustrative, and not restrictive. Concepts illustrated in the examples may be applied to other examples and implementations.

In situations in which certain implementations discussed herein may collect or use personal information about users (e.g., user data, user's location and time at the location, user's biometric information, user's activities and demographic information, information about a user's social network), users are provided with one or more opportunities to control whether information is collected, whether the personal information is stored, whether the personal information is used, and how the information is collected about the user, stored and used. That is, the systems and methods discussed herein collect, store and/or use user personal information specifically upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user device's geographic location may be generalized to a larger region so that the user's particular location cannot be determined.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement operations of particular implementations. Different programming techniques may be employed, e.g., procedural or object-oriented. The operations may execute on a single processing device or multiple processors. Although steps, operations, or computations may be presented in a specific order, the order may be changed in different particular implementations and/or multiple operations shown as sequential in this specification may be performed at the same time.

1. A mobile device comprising:
at least one processor;
one or more motion sensors, wherein the one or more motion sensors are configured to provide sensor data to the at least one processor;
a phased array antenna module including an antenna array including a plurality of antennas arranged linearly along a first axis; and
a rotary actuator coupled to the phased array antenna module and configured to rotate the phased array antenna module about a second axis that is parallel to the first axis,
wherein the at least one processor is configured to perform operations including:
determining an orientation of the mobile device based at least on the sensor data from the one or more motion sensors; and
providing control signals based on the orientation of the mobile device to the rotary actuator to cause the rotary actuator to rotate the phased array antenna module about the second axis.

2. The mobile device of claim 1, wherein the rotary actuator includes a motor including a rotor, and further comprising an elongated shaft coupled to the rotor and to a substrate of the phased array antenna module, wherein the elongated shaft extends along the second axis, and wherein the motor is configured to rotate the elongated shaft to cause the phased array antenna module to rotate about the second axis.

3. The mobile device of claim 1, wherein the rotary actuator is a first rotary actuator, and further comprising a second rotary actuator coupled to the phased array antenna module, wherein the second rotary actuator is configured to rotate the phased array antenna module about a third axis that is orthogonal to the first axis.

4. The mobile device of claim 1, wherein the at least one processor is configured to perform further operations comprising:
causing a millimeter wave (MMW) signal to be transmitted via the phased array antenna module, wherein the transmitted MMW signal is moved toward a receiving device via the rotation of the phased array antenna module about the second axis.

5. The mobile device of claim 1, wherein the motion sensors include one or more gyroscopes.

6. The mobile device of claim 1, wherein the at least one processor is configured to control the antennas to steer antenna beams about a second axis.

7. A method in a mobile communication device including a phased array antenna module that includes a plurality of antennas arranged along a first axis, the phased array antenna module coupled to a rotary actuator, the method comprising:
determining, by at least one processor, a direction of a base antenna relative to the mobile communication device;
detecting a change in orientation of the mobile communication device;
responsive to the detected change in orientation, sending first control signals to the rotary actuator of the mobile communication device to cause the phased array antenna module to rotate about a second axis toward the base antenna, wherein the second axis is parallel to the first axis; and
causing signals to be transmitted by the antennas in a second direction resulting from the rotation of the phased array antenna module.

8. The method of claim 7, further comprising:
determining, by the at least one processor, that the phased array antenna module is misaligned with the base antenna by being oriented in a first direction that is spaced from the base antenna by an angle amount; and
wherein sending the first control signals to the rotary actuator to cause the phased array antenna module to rotate about a second axis includes causing the phased array antenna module to selectively rotate based on the angle amount.

9. The method of claim 7, wherein:
the rotary actuator includes a motor including a rotor,
an elongated shaft is coupled to the rotor and to a substrate of the phased array antenna module,
the elongated shaft extends along the second axis, and
the motor is configured to rotate the elongated shaft to cause the phased array antenna module to rotate about the second axis.

10. The method of claim 7, wherein the rotary actuator is a first rotary actuator, and further comprising sending second control signals to a second rotary actuator coupled to the phased array antenna module to cause the phased array antenna module to rotate about a third axis toward the base antenna, wherein the third axis is orthogonal to the first axis and to the second axis.

11. The method of claim 7, wherein causing the signals to be transmitted includes providing electronic beam steering of the signals to rotate a direction of transmission of the signals about a third axis that is transverse to the first axis.
